(19) United States
(12) Patent Application Publication
(10) Pub. No.: US 2020/0319639 A1
(43) Pub. Date: Oct. 8, 2020

(54) Sensors for Mapping Potential Turning Manuevers for Convoys of Autonomous Vehicles

(71) Applicants: Alberto Daniel Lacaze, (US); Karl Nicholas Murphy, Gaithersburg, MD (US)

(72) Inventors: Alberto Daniel Lacaze, Potomac, MD (US); Karl Nicholas Murphy, Rockville, MD (US)

(73) Assignee: Alberto Lacaze, Gaithersburg, MD (US)

(21) Appl. No.: 16/377,699

(22) Filed: Apr. 8, 2019

(51) Int. Cl. G05D 1/00; G05D 1/02

(52) U.S. Cl. CPC G05D 1/0088; G05D 1/0231; G05D 2201/0213; G05D 1/0293; G05D 1/0255

(57) ABSTRACT

The use of sensors such as a LADAR, a ranging sensor, or an acoustic sensor in the front of the autonomous vehicles having to remember that there is one or more places to turn around (U-turn, k-turn, and other turning maneuvers) when there are obstacles in the path of the convoy and that the first autonomous vehicle mapping areas where k-turns, U-turns, and other turning maneuvers are possible for the entire convoy if necessary. These sensors detect features in a road network. There is also a control mechanism in which the first autonomous vehicle turns around in an orderly manner. Some examples include first autonomous vehicle backing out all the way and second one turning around or all of them back out and one turns around. In addition, the turning areas are paired with a specific turning maneuver and turning areas are marked for future traversals by the convoy.

### CROSS-REFERENCES TO OTHER APPLICATIONS

None.

### BACKGROUND OF THE INVENTION

### 1. Field of the Invention

The present invention relates to the use of sensors such as a LADAR, a ranging sensor, or an acoustic sensor in the front of the autonomous vehicles to map one or more turning areas where U-turns, k-turns and other turning maneuvers can be used as well as the first truck mapping information for where the entire convoy can turn around if needed. In addition, there is a control mechanism in which the first autonomous vehicle turns around in an orderly manner. Some examples include first autonomous vehicle backing out all the way and second one turning around or all of them back out and one turns around. There could also be two areas where U-turns, k-turns, or other turning maneuvers are possible when there are obstacles in the path of the convoy. In addition, the specific turning area detected by the lead autonomous vehicle or other autonomous vehicles is paired with a particular maneuver and also the turning areas are marked for future traversals by the autonomous convoy.

### 2. Description of Related Art

The statements in this section merely provide background information related to the present disclosure and may not constitute prior art.

There is a great need for the development of a system in which autonomous vehicles can turn around in an orderly manner via different types of turning maneuvers such as U-turns, k-turns, and reversals when there are obstacles present in their path. This type of system is especially important when there are many obstacles present in front of the autonomous vehicles. There have been no reports in the literature of such a system being developed.

There has been a reversal system established for a train running system which is based on a shuttle system which does not rely of the use of sensors. A train running system constructed on a shuttle system such that a plurality of trains are allowed to run in reversals in two directions on single track lines furnished on the way with a branch part of the trains, to make passing by, whereby the trains running in opposite directions are prevented from collision and this is discussed in JP20022046611A.

There has been a method developed for reversing the driving direction as shown in DE Pat. No. 60212384T2. This involves a brake-initiated action and does not involve the use of sensors to allow the trucks to go backwards or make k-turns.

There are some systems that use electromagnetic sensing for vehicle guidance using a single signal carrying wire or conductor as discussed in U.S. Pat. No. 3,038,070 but these systems are very difficult to use in cases where the road is muddy, bumpy, or require extensive grading. In addition, it is difficult with a one-wire guidance path system to remotely stop one vehicle in a predetermined portion along the guidance path or direct one vehicle to take a particular one of a number of branches where sections of the guidance path intersect, without affecting the movement of other vehicles that are also moving along other portions or sections of the guidance path. Some two wire guidance systems solve these problems but create additional problems such as when the paths of the two wires cross each other and when it is desired to stop or turn one vehicle around.

Electromagnetic sensors have not been used to selectively turn trucks in a convoy of trucks or turn around an entire convoy of trucks. The present invention involves having sensors in the front of all the trucks including the lead truck that remember turnaround points for other trucks. The front truck also remembers turnaround points for the entire convoy.

A method has been developed for controlling a convoy of motor vehicles to perform a reverse movement as discussed in EP 3190008A1. This invention involves a road automobile convoy of first and second vehicles attached to each other and the control, with a movement in reverse of the first and second hinge devices of the first and second vehicle so as to maintain the trajectory followed by the geometric center of a front wheel of the first tangent vehicle a turning circle whose center is located at the intersection of transverse axes medium of wheels and rear road automobile convoy. In this method, there are no sensors that are used to retain memory of turnaround points when they arise.

### SUMMARY OF THE INVENTION

The present invention consists of a convoy of autonomous vehicles that have sensors in front of them that must remember turning areas where they can turn backwards or do k-turns or other turning maneuvers such as U-turns when an obstacle is reached in their path.

There is a control mechanism in which they go backward or turn around via different turning maneuvers in an orderly fashion.

The lead autonomous vehicle also must look for possible areas for U-turns, k-turns, and other turning maneuvers for the entire convoy if possible.

One example would be if the first autonomous vehicle goes all the way back and the second one turns around. Another example would be if all of the autonomous vehicles turn back and then one turn around.

In addition, there could be two areas where U-turns, k-turns, or other turning maneuvers can be made if the convoy reaches obstacles in their path.

The specific turning areas that are sensed by the lead autonomous vehicle or other autonomous vehicles are paired with each specific turning maneuver such as a U-turn, k-turn, or reversal. In addition, the turning areas are also marked for future traversals or movements by the autonomous convoy.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1 shows a convoy of autonomous vehicles (102) containing sensors in the front of them and the lead autonomous vehicle in the front heading toward an obstacle (100) in the path in the road network (101).

FIG. 2 shows an example of the lead autonomous vehicle (202) backing out all the way in the road network (200) and then second autonomous vehicle (201) making a U-turn around in the turning area (203).

FIG. 3 shows an example of the entire convoy of autonomous vehicles (302) backing out all the way in the road network (300) and another autonomous vehicle (301) making a U-turn around in the turning area (303).

FIG. 4 shows an example where there are two areas where U-turns can be made, and the lead autonomous vehicle (402) backs all the way out in the road network (400) and an autonomous vehicle (401) makes a U-turn in each of these turning areas (403).

FIG. 5 shows an example where there are two areas where U-turns can be made, and the entire convoy of autonomous vehicles (502) backs all the way out in the road network (500) and an autonomous vehicle (501) makes a U-turn in each of these areas (503).

### DETAILED DESCRIPTION OF INVENTION

The particulars shown herein are given as examples and are for the purposes of illustrative discussion of the embodiments of the present invention only and are presented in the cause of providing what is believed to be the most useful and readily understood description of the principles and conceptual aspects of the present invention.

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

The autonomous vehicles have sensors in front of them which comprise a camera, LADAR, ranging sensor, or acoustic sensor on a road network. There is a communication mechanism between the database of features of the first autonomous vehicle and the database of features of the rest of the autonomous convoy. There is also a localization system that is present between the two sets of vehicles.

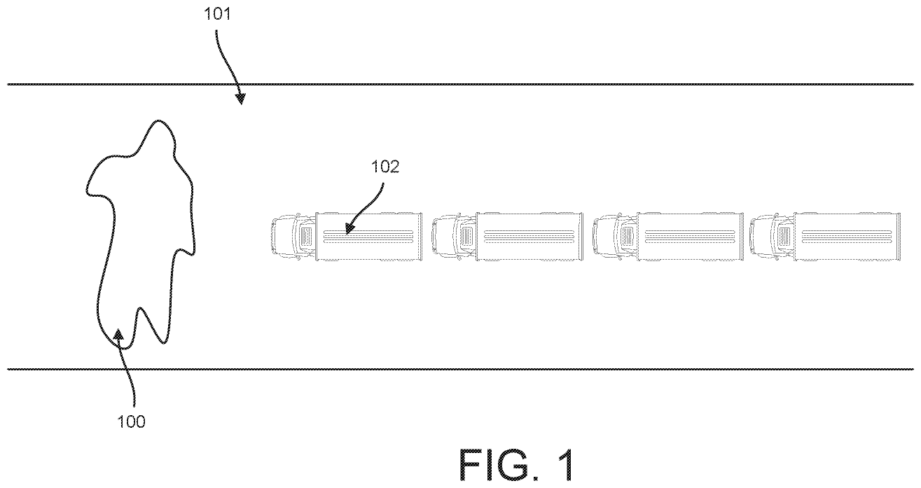

FIG. 1 illustrates a convoy (102) of autonomous vehicles that have sensors in the front that are designed to remember locations where the autonomous vehicles can be reversed or turned around (k-turns U-turns, or other turning maneuvers). The sensors of the lead autonomous vehicle also determine locations where the entire convoy (102) can be turned around if necessary. In this figure the autonomous vehicles are headed towards an obstacle (100) that is present in their path in the road network (101).

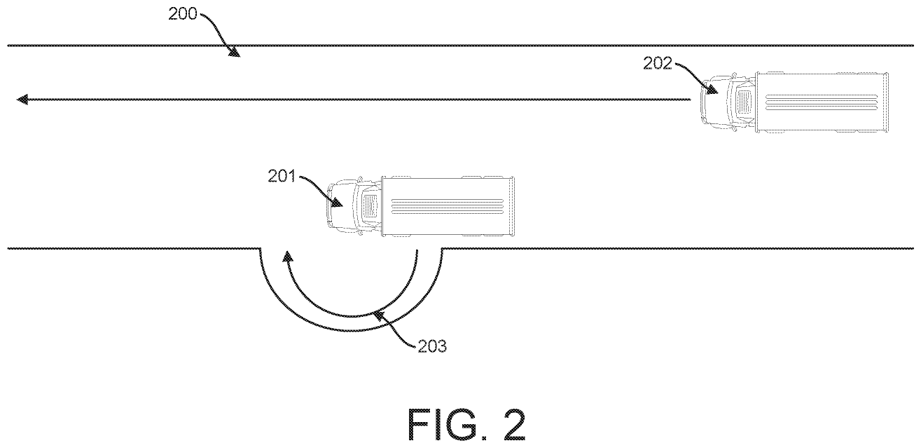

FIG. 2 illustrates an example in which the lead autonomous vehicle (202) backs all the way out and detects areas where the second autonomous vehicle (201) can turn around. Then a second autonomous vehicle turns around via a U-turn in a turning area (203) that was detected by the lead autonomous vehicle (202). The sensors in the front of the lead autonomous vehicle must remember specific locations in the road network (200) in which an entire convoy can be turned around depending on the obstacle. Other types of areas can also be mapped for k-turns and other types of turning maneuvers.

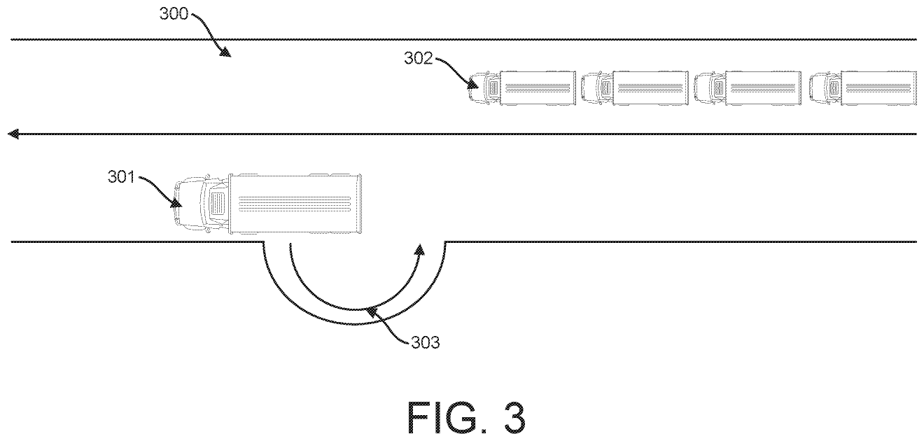

FIG. 3 illustrates an example in which the lead autonomous vehicle and the rest of the autonomous convoy (302) backs all the way out and detects areas in the road network (300) where another autonomous vehicle (301) can turn around via a k-turn, U-turn, or another turning maneuver. In this case, the autonomous vehicle (301) makes a U-turn in the road network (300).

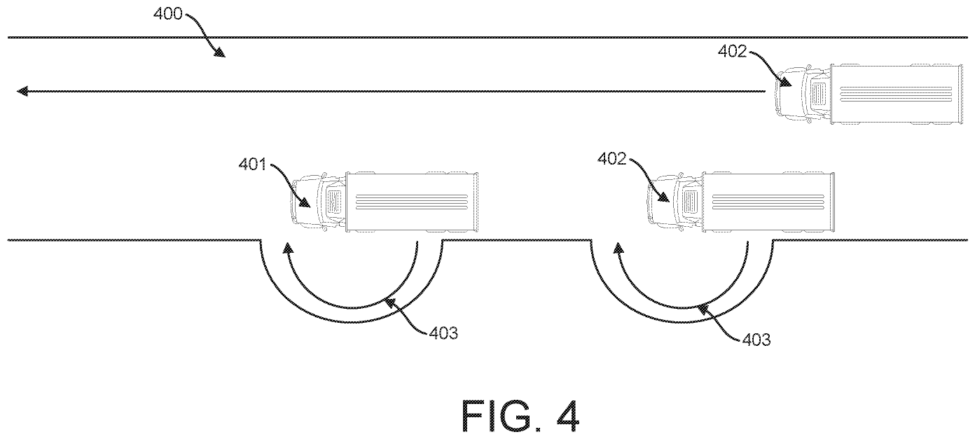

FIG. 4 illustrates an example in which there are two turning areas (403) in which autonomous vehicles can turn around. A lead autonomous vehicle (402) backs all the way out, detects the specific areas where the autonomous vehicles can turn around in the road network (400), and then there is an autonomous vehicle (401, 402) turning around in each of the U-turn turning areas (403). This type of turning can also be conducted for k-turns and other types of turning maneuvers. The turning maneuver is not limited to just k-turns, U-turns, and reversals and includes a wide variety of other turning maneuvers.

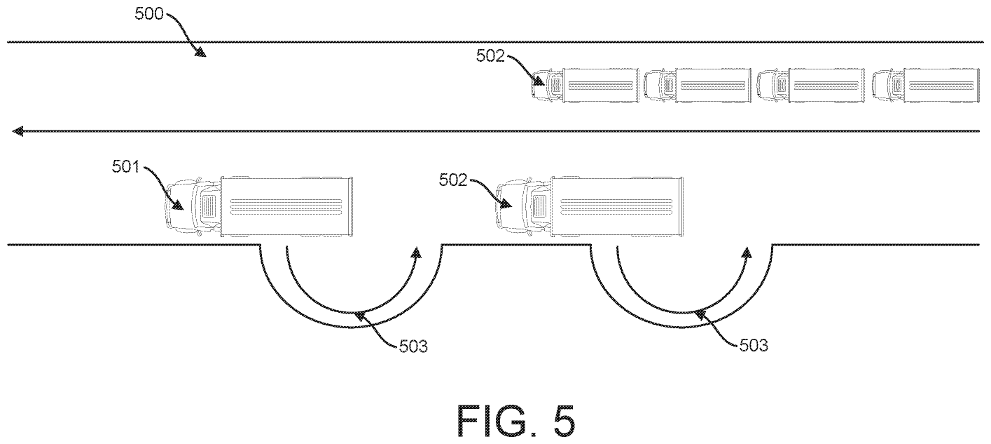

FIG. 5 illustrates an example in which there are two turning areas (503) in which autonomous vehicles can turn around in which the entire autonomous convoy (502) backs all the way out. The sensors in the autonomous vehicles (502) detect the areas where the rest of the autonomous vehicles can safely turn around and two autonomous vehicles (501, 502) make U-turns in the two turning areas (503) that are present in the road network (500). Other turning maneuvers such as k-turns can also be conducted.

The turning areas that are sensed by the lead autonomous vehicle are paired with specific turning maneuvers. For example, one turning area could be paired with a U-turn while another turning area could be paired with a k-turn.

In addition, the specific turning areas that are mapped by the lead autonomous vehicle are also marked for future traversals or movements by the autonomous convoys.

1. A system of mapping a turning area for autonomous vehicles to turn around comprising a set of sensors.

2. The system of claim 1 wherein the sensor is a LADAR or an acoustic sensor or a ranging sensor.

3. The system of claim 1 wherein there is a communication mechanism between a database of features of the first autonomous vehicle and a database of features of the rest of the convoy.

4. The system of claim 1 wherein there is a localization system present in the two databases.

5. The system of claim 1 wherein the lead autonomous vehicle or autonomous vehicles turn backwards.

6. The system of claim 1 wherein the sensor detects areas in the road network for autonomous vehicles to turn around.

7. The system of claim 1 wherein the autonomous vehicles conduct a turning maneuver.

8. The system of claim 1 wherein the turning maneuver includes a k-turn or a U-turn or a reversal.

9. The system of claim 1 wherein two or more turning areas can be detected.

10. The system of claim 1 wherein the turning areas are paired with a particular turning maneuver.

11. The system of claim 1 wherein the turning areas are marked for future traversals by the autonomous convoy.
